(19) United States
(12) Patent Application Publication
(10) Pub. No.: US 2015/0310218 A1
(43) Pub. Date: Oct. 29, 2015

(54) SYSTEMS AND METHODS FOR SECURE DISTRIBUTION OF CODES

(71) Applicant: Verify Brand, Inc., Minneapolis, MN (US)

(72) Inventor: Jason GEYEN, Maple Grove, MN (US)

(21) Appl. No.: 14/696,840

(22) Filed: Apr. 27, 2015

Related U.S. Application Data
(60) Provisional application No. 61/984,881, filed on Apr. 28, 2014.

(51) Int. Cl. G06F 21/60; H04L 12/58

(52) U.S. Cl. CPC G06F 21/60; G06F 21/606; H04L 51/28

(57) ABSTRACT

Systems and methods for secure distribution of codes involve providing messages to end-users that include links. When one of the messages is accessed by an end-user, one of the links is accessed and a code is rendered in the message based on the accessed link. The end-user can then redeem the code for something of value.

### CROSS-REFERENCE TO RELATED APPLICATIONS

This application claims priority under 35 U.S.C. §119 to U.S. Provisional Application 61/984,881, filed Apr. 28, 2014, the entire disclosure of which is herein expressly incorporated by reference.

### BACKGROUND OF THE INVENTION

Exemplary embodiments of the present invention are directed to systems and methods for secure distribution of codes. Codes can come in a variety of different forms and can be used for a variety of different purposes. For example, Universal Product Codes (UPCs) are typically in the form of barcodes printed on product packaging and are used by merchants to scan products at a checkout register. Numeric and alphanumeric codes are often used in connection with promotions. For example, a code printed on the inside of a bottle cap can be redeemed for a reward. Codes are also typically used for authentication of software, such as authentication codes that are included along with product packaging that are used for authentication of Microsoft Corporation's software products.

### SUMMARY OF THE INVENTION

Each code used in connection with promotions and authentication is intended to be unique from other codes used in a particular promotion or authentication so that they cannot be reused. Accordingly, it is typically necessary to provide some type of protection of the code so that it is only used by the intended recipient. There are a variety of different ways of protecting the integrity of codes directly associated with physical goods, e.g., printed on product packaging or included inside of product packaging. The codes could be printed on a portion of the product packaging that is not typically accessible until after the purchase, e.g., inside of the packaging. Similarly, codes could be printed separately from the product packaging but placed inside of the product packaging prior to being sealed.

Although protecting the integrity of codes of physical goods is relatively easy, this is not the case for codes distributed by electronic means, e.g., by electronic mail. If a code is contained within an electronic mail as plain text, the electronic mail could easily be intercepted and/or forwarded to others. Interception is problematic for single-use codes because the code may be redeemed and marked as invalid for future redemptions before the intended recipient attempts to redeem the code. Forwarding of codes can be problematic for multiple-use codes because the company distributing and accepting the multi-use codes may intend that the codes are only used by persons that are specifically targeted by the company. Thus, when the multiple-use code is forwarded in an electronic mail, the persons redeeming the code may not be those that were the company's intended targets.

Accordingly, exemplary embodiments of the present invention are directed to systems and methods of securely distributing codes. In accordance with exemplary embodiments of the present invention a plurality of unique hash values are generated and a plurality of unique addresses are generated for each of the plurality of unique hash values. The plurality of unique addresses are then distributed to end-users in a respective plurality of messages. When one of the messages is accessed by an end-user, a request is directed to one of the plurality of unique addresses and a particular code is identified as corresponding to the particular unique address. An image is then created that contains the code and the image is provided to the requestor for display as part of the message.

### BRIEF DESCRIPTION OF THE DRAWINGS

FIGS. 1A and 1B are block diagrams illustrating two exemplary systems in accordance with the present invention;

FIG. 2 is a flow diagram illustrating an exemplary method in accordance with the present invention;

FIG. 3A is a block diagram of the source code of an exemplary electronic mail message in accordance with the present invention; and

FIG. 3B is a block diagram of an exemplary electronic mail message in accordance with the present invention.

### DETAILED DESCRIPTION OF THE DRAWINGS

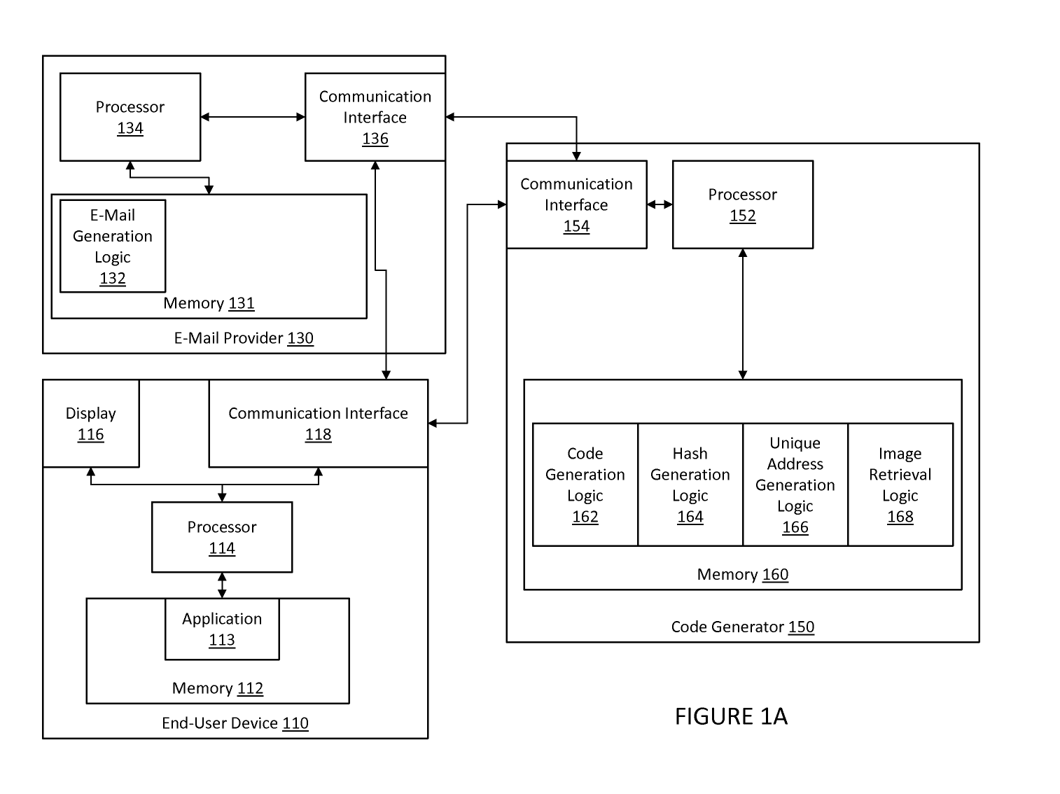

FIG. 1A is a block diagram of an exemplary system in accordance with the present invention. The exemplary system includes an end-user device 110 that can receive an electronic mail message from an electronic mail provider 130. The electronic mail message does not contain a code itself but instead a link to an address of code generator server 150. Accordingly, when the end-user device opens the electronic mail message the address is automatically accessed to obtain an image containing the code from code generator server 150. The image can then be displayed as part of the electronic mail message on display 116 of end-user device 110.

The end-user device 110 can be any type of device, including a cellular telephone, smart phone, personal digital assistant (PDA), computer, tablet, slate, and/or the like. The end-user device includes a memory 112 that can store one or more electronic mail applications 113, which applications are executed by processor 114. The electronic mail application 113 can be any type of electronic mail application capable of interpreting HTML and generating a corresponding electronic mail message for display in accordance with the HTML code contained in the electronic mail. Processor 114 is connected to communication interface 118, which can be one or more communication interfaces that support wired and/or wireless communications. For example, communication interface 118 can support wide area network cellular wireless communications (e.g., CDMA, LTE, GSM, WiMAX, etc.) and short-range wireless communication (e.g., Bluetooth, near-field communications (NFC), RF-ID, infrared (IR), WiFi, etc.). The end-user device also includes a display 116, which can display, among other things, an electronic mail message to an operator of the end-user device.

Electronic mail provider 130 includes a processor 134 operatively coupled to a memory 131 and a communication interface 136, which can be one or more communication interfaces that support the same or different types of wired and/or wireless communications as communication interface 118 of end-user device 110. Memory 131 stores one or more programs embodied as logic 132, which is executed by processor 134 to perform certain functions, which will be described in more detail below

Code generator server 150 includes non-transitory memory 160, which stores one or more programs embodied as logic 162-168. This logic is executed by processor 152 to perform certain functions, which will be described in more detail below. Communication interface 154 can be one or more communication interfaces that support the same or different types of wired and/or wireless communications as communication interface 118 of end-user device 110 and communication interface 136 of electronic mail provider 130.

The various processors described above can be microprocessors, field programmable gate arrays (FPGA), and/or application specific integrated processors (ASIC). These various processors are specifically programmed to carry out the functions disclosed and claimed in the present application.

Although FIG. 1 illustrates a single end-user device 110 interacting with a single electronic mail provider 130 and a single code generator server 150, the present invention is not so limited. For example, end-user device 110 can interact with more than one electronic mail provider 130 and electronic mail provider 130 can interact with more than one end-user device 110. Similarly, end-user device 110 can interact with more than one code generator server 150 and code generator server 150 can interact with more than one end-user device. Moreover, electronic mail provider 130 can interface with more than one code generator server 150 and code generator server 150 can interact with more than one electronic mail provider 130.

FIG. 1B is a block diagram of a system similar to that illustrated in FIG. 1A. The difference between these two figures is that in FIG. 1A the code generator server 150 includes the necessary logic for generating the unique addresses, whereas in FIG. 1B the electronic mail provider 130 contains this logic.

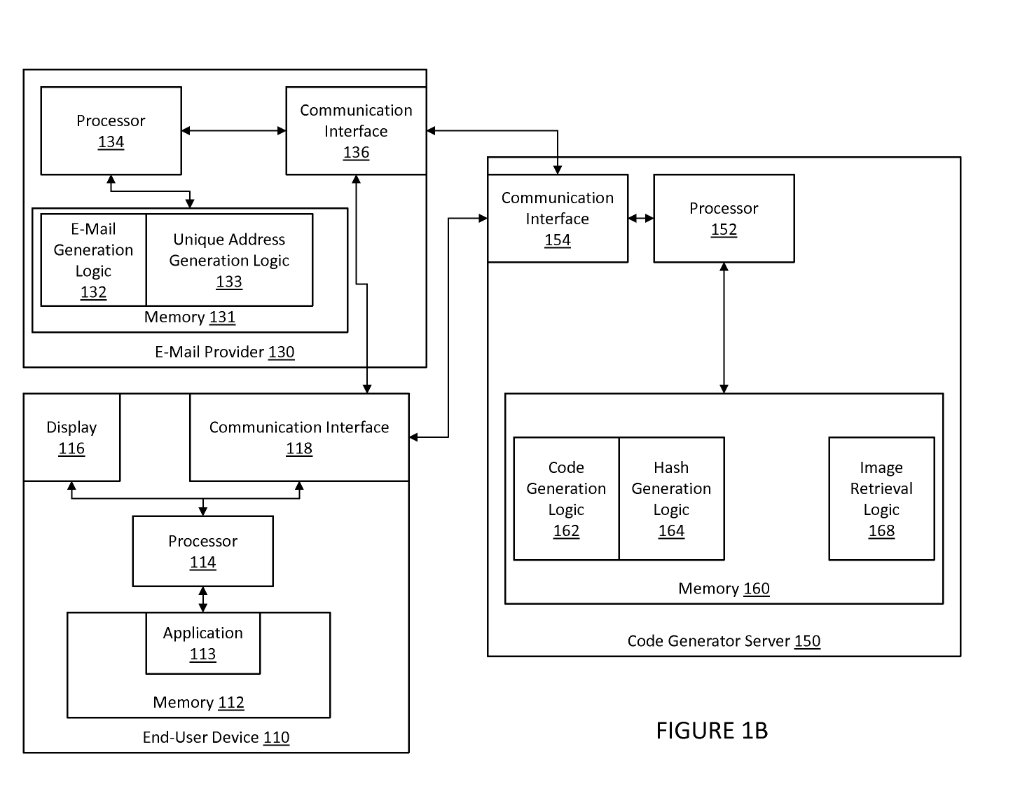

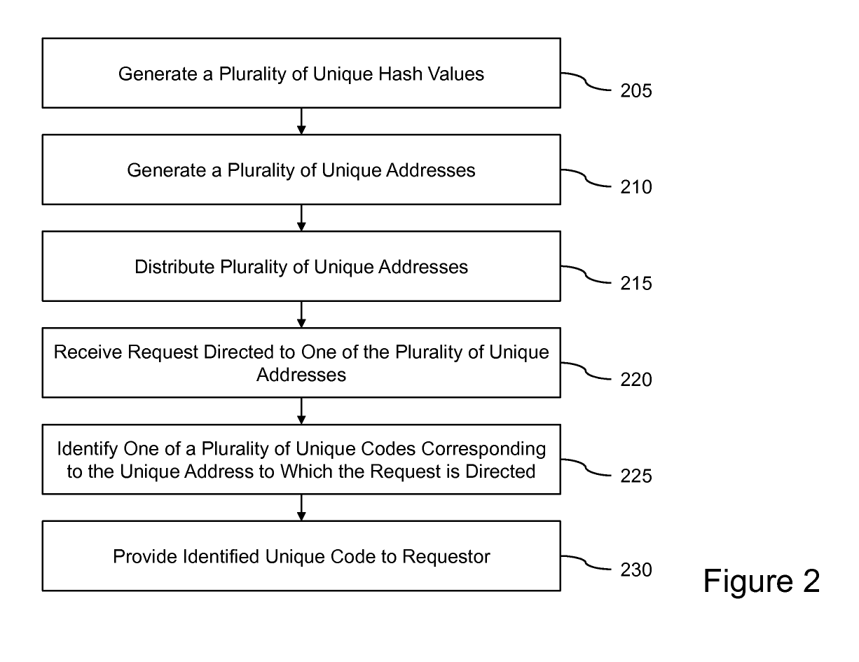

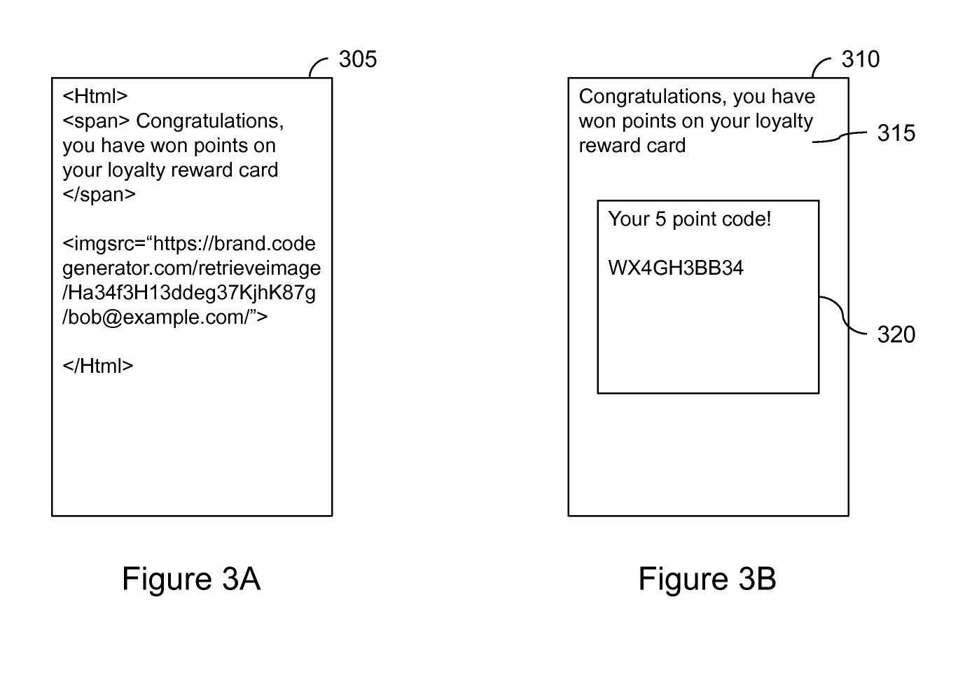

The systems illustrated in FIGS. 1A and 1B will now be described in connection with the flow diagram of FIG. 2 and the electronic mail messages illustrated in FIGS. 3A and 3B. As will be described in more detail below, the present invention can used to securely deliver codes used as part of a promotional campaign. These codes can be generated by logic 162 of code generator server 150 using any technique that produces a plurality of unique codes, such as those disclosed in U.S. Pat. Nos. 7,752,137, 7,917,443, 7,996,319, 8,280,817, and 8,615,470, the entire disclosures of which are herein expressly incorporated by reference. The unique codes can be generated in bulk prior to the distribution of the unique addresses or as requests are received directed to the unique addresses. In accordance with the present invention these codes are provided to a person associated end-user device 110, who can redeem the code in connection with a promotional offer, such as a coupon and/or as part of a loyalty reward program. The promotional offer can involve the distribution of coupons with a variable redemption characteristic, such as those disclosed in U.S. Provisional Application No. 61/836,918, filed Jun. 19, 2013, the entire disclosure of which are herein expressly incorporated by reference.

Initially, code generator server 150 uses hash generation logic 164 to generate a plurality of unique hash values (step 205). If the promotional campaign employs single-use codes the number of unique hash values corresponds to the number of intended recipients for the promotional campaign. If the promotional campaign uses multiple-use codes, the number of unique hash values can be equal to or less than the number of intended recipients.

The unique hash values can be generated using a secret identifier (e.g., a campaign identification associated with the promotion) and a known identifier (e.g., the recipient's e-mail address). If the code generator server 150 generates the unique addresses, then code generator server 150 uses logic 166 to generate the unique addresses using the unique hash values (step 210). If, however, electronic mail provider 130 generates the unique addresses, then code generator server 150 provides the plurality of generated unique hash values to electronic mail provider 130, which then uses logic 133 to generate the plurality of unique addresses corresponding to the plurality of hash values. The secret identifier and e-mail address can be stored by the code generator server 150 along with the hash to speed performance of validating a subsequently received request for a code directed to a particular address.

Assuming, for example, that the intended recipient has the electronic mail address bob@example.com and the secret identifier is 211a1ff98cea435c936e0022e234b3b4, the address generated using the hash algorithm can be

https://brand.codegenerator.com/retrieveimage/Ha34f3H13ddeg37KjhK87g/bob@example.com/.

Those skilled in the art refer to the address following “https://” as a Uniform Resource Locator (URL). In the address above the unique hash value is “Ha34f3Hl3ddeg37KjhK87g”, which in combination with the recipient's electronic mail address produces a unique address. Of course, the unique hash alone will also produce the unique address. It should be recognized that the present invention is not limited to the use of a particular hashing algorithm used to produce the unique hash value.

Once the unique addresses are generated then the electronic mail provider 130 uses logic 132 to generate a plurality of electronic mail messages, each containing one of the unique addresses, and distributes these messages (step 215). The messages can be distributed in bulk or over time. FIG. 3A illustrates an exemplary electronic mail message in accordance with the present invention, which is formatted using HTML coding. As will be recognized by those skilled in the art, the HTML tag <span> indicates text that should be grouped together. As will also be recognized by those skilled in the art the HTML tag <imgsrc> indicates the source of an image to be displayed, which in this case is obtained using the address following “https://”.

Accordingly, when the electronic mail message is opened by the end-user device 110, the application 113 causes the processor 114 to display the text bounded by the HTML tag <span>and to send a request to retrieve the image from the address following “imgsrc” (step 220). When code generator server 150 receives the request directed to the address following “imgsrc”, logic 168 identifies one of the plurality of unique codes corresponding to the unique address (step 225). This involves parsing the request to obtain the hash and electronic mail address (if present), validating the hash and electronic mail address to ensure they match for a particular secret identifier, allocating a code for the specific hash, and creating an image for the allocated code. If the code is a single-use code the code generator server 150 also marks the identified code as used so that further attempts to access the particular unique address will not result in the provision of the particular code associated with the unique address. If the code is a multiple-use code the code generator server 150 increments the number of uses of the identified code as used so that the code is only accessed the desired number of times before it can no longer be accessed via the unique address.

Once the particular unique code has been identified, it is provided to the end-user device as an image (step 230). Application 113 causes processor 114 of the end-user device 110 to display the HTML formatted electronic mail message including the retrieved image, and example of which is illustrated in FIG. 3B. The unique code can be provided using any type of image, such as a JPEG or GIF formatted image. To the extent that the end-user device does not include an application capable of interpreting HTML codes and reproducing HTML formatted messages, or if these capabilities are disabled, the end-user device would still be able to access the code by selecting the hyperlink to the particular address, which would then cause the image to displayed by an HTML-capable application, such as an Internet browser, word processing program, and/or the like.

It should be recognized that the electronic mail messages in FIGS. 3A and 3B are merely exemplary and that the messages can have different formatting so long as the original message sent from the electronic mail provider 130 to the end-user device 110 does not contain the code itself and that the end-user device 110 must retrieve the code upon opening the electronic mail message.

It should also be recognized that the use of electronic mail messages is merely exemplary and that any medium can be employed so long as the original message sent to the end-user device 110 does not contain the code itself and that the end-user device 110 must retrieve the code upon opening the document. Thus, for example, the present invention could be implemented using Multimedia Messaging Service (MMS), in which case the electronic mail provider would be an MMS provider. In this case, the MMS messages are distributed to a plurality of electronic mail addresses and/or telephone numbers.

By providing codes as a hyperlinked image in an electronic mail message the present invention not only protects codes from interception during the transmission of the electronic mail message from the electronic mail provider 130 to the end-user device 110 but also protects the codes from improper diversion by the electronic mail provider 130. This is particularly important because the codes themselves have a certain amount of value associated with them. Further, in the case of single-use or limited, multiple-use codes, this prevents customer dissatisfaction that would otherwise occur if a customer attempted to use a code that has been marked as invalid due to a previous use or redemption of the code.

In addition to increased security for the codes, the present invention also provides the ability to modify the code and/or the redemption value associated with the code at any time until the electronic mail message is opened and the image is retrieved using the hyperlink address in the message. Specifically, the image that is provided by accessing the particular address can be substituted at any time. Further, as discussed above, the present invention can use a variable redemption characteristic for determining the code and/or redemption value associated with the code. Thus, for example, the code and/or associated redemption value can be changed depending upon where and/or when the electronic mail message is opened and the image with the code is retrieved. The code generator can also use any information obtained as to when and where the electronic mail message is opened for a variety of purposes, such as evaluating the effectiveness of a particular promotional campaign.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method, comprising:
generating, by a processor, a plurality of unique hash values;
generating, by the processor, a unique address for each of the plurality of unique hash values;
distributing, by the processor, each of the plurality of unique addresses;
receiving, by the processor from a requestor, a request directed to one of the plurality of unique addresses;
identifying, by the processor, one of a plurality of unique codes corresponding to the one of the plurality of unique addresses to which the request is directed; and
providing, by the processor, the identified unique code to the requestor.

2. The method of claim 1, wherein each of the plurality of unique hash values are generated by applying a secret identifier and a unique known value to a hash algorithm and the identification of the one of the plurality of unique codes involves
parsing the one of the plurality of unique addresses to which the request is directed to obtain a hash value and the unique known value;
validating the obtained hash value and the unique known value against a stored hash value and unique known value for the one of the plurality of unique addresses to which the request is directed;
allocating the one of the plurality of unique codes; and
generating an image containing the one of the plurality of unique codes.

3. The method of claim 1, wherein the network address generated for each of the plurality of unique hash values includes the corresponding hash value.

4. The method of claim 3, wherein the network address generated for each of the plurality of unique hash values further includes an electronic mail address of a recipient of one of the plurality of unique codes.

5. The method of claim 1, wherein the network address is a uniform resource locator (URL).

6. The method of claim 1, wherein the processor distributes each of the plurality of unique addresses to an electronic mail service provider and the electronic mail service provider distributes each of the plurality of unique addresses in separate electronic mail messages to a plurality of electronic mail addresses.

7. The method of claim 6, wherein the plurality of unique addresses are included in the plurality of electronic mail messages as a hyperlink to one of the plurality of unique addresses and the unique code is provided to the requestor as an image file.

8. The method of claim 7, wherein opening of one of the plurality of electronic messages automatically sends the request to the processor.

9. The method of claim 1, wherein the request received by the processor includes an electronic mail address of the requestor.

10. The method of claim 1, wherein the processor that generates the codes is a different processor from the processor that generates the plurality of hash values and the plurality of unique addresses.

11. The method of claim 1, wherein the processor distributes each of the plurality of unique addresses to a Multimedia Messaging Service (MMS) service provider and the MMS service provider distributes each of the plurality of unique addresses in separate MMS messages to a plurality of electronic mail addresses or telephone numbers.

12. The method of claim 1, wherein the one of the plurality of unique codes has an associated redemption value.

13. The method of claim 12, wherein the associated value is selected based on a variable factor.

14. The method of claim 13, wherein the variable factor is an amount of time between when one of the plurality of unique addresses is provided to the requestor and when the requestor sends the request directed to the one of the plurality of unique addresses.

15. The method of claim 13, wherein the variable factor is a location from which the request is transmitted to the processor.
